(19) United States
(12) Patent Application Publication
(10) Pub. No.: US 2018/0371995 A1
(43) Pub. Date: Dec. 27, 2018

(54) ROTATING DEVICES FOR MITIGATION OF ADVERSE FLOW CONDITIONS IN AN ULTRA-SHORT NACELLE INLET

(71) Applicant: The Boeing Company, Chicago, IL (US)

(72) Inventors: Andrew M. Dorsey, Long Beach, CA (US); Drew C. Hoffman, Long Beach, CA (US); Francisco D. Palacios, Long Beach, CA (US); Zachary C. Hoisington, Long Beach, CA (US)

(21) Appl. No.: 15/633,523

(22) Filed: Jun. 26, 2017

(51) Int. Cl. F02C 7/042; F02C 7/057; B64D 27/18; B64D 29/06; B64D 33/02

(52) U.S. Cl. CPC F02C 7/042; F02C 7/057; F05D 2220/323; B64D 29/06; B64D 33/02; B64D 27/18

(57) ABSTRACT

A flow control system on an aircraft engine nacelle incorporates a plurality of flow control devices each having a body. A second plurality of actuators is coupled to the body of an associated one of the flow control devices. The actuator rotates the body about a leading edge of an inlet of a nacelle from a retracted position to an extended position.

### REFERENCE TO RELATED APPLICATIONS

This application is co-pending with application Ser. No. ______ entitled TRANSLATING TURNING VANES FOR A NACELLE INET with attorney docket no. 17-0170-US-NP, filed substantially concurrently herewith and having a common assignee.

### BACKGROUND INFORMATION

### Field

Exemplary embodiments of the disclosure relate generally to aerodynamic flow control for turbofan aircraft nacelles and more particularly to flow control devices on the leading lip of ultra-short nacelles.

### Background

Turbofan engines are widely employed for large commercial aircraft. As engines become larger and fans become wider, nacelles housing the fans must become shorter to achieve lower fuel burns (lower drag and weight). However, shorter nacelles, especially the resulting shorter inlets means that at adverse conditions such as high angles of attack (takeoff and over-rotation) or crosswind conditions the flow is more likely to separate behind the leading edge of the short inlet. The short inlet's smaller leading edge radius, and other features, makes it more difficult for flow to stay attached when airflow entering the engine must turn before heading in a direction approximately normal to the fan-face. If the flow separates at the leading-edge of the nacelle, the resulting flow distortion (total pressure decrease) at the fan-face is undesirable. The separated flow may reduce performance, increase noise, and require heavier support structure to mitigate aerodynamically induced vibration. Existing solutions include simply making the inlet longer and adding a thicker lip. Alternatively blow-in doors used earlier nacelle designs may be employed. However, making the inlet longer is not an optimal solution with very large engine diameters as it reduces effectiveness of the larger engine by creating excess drag and weight. Blow-in doors increase emitted noise from aircraft operations and are structurally complex. It is therefore desirable to provide alternative solutions for inlet flow control which overcome the constraints of prior art solutions and provide improved performance.

### SUMMARY

As disclosed herein a flow control system on an aircraft engine nacelle incorporates a plurality of flow control devices each having a body. An additional plurality of actuators is coupled to a trailing edge of the body of an associated one of the flow control devices. The actuator rotates the body about a leading edge of an inlet of a nacelle from a retracted position to an extended position.

The embodiments disclosed provide a method for inlet flow control on an ultra-short turbofan engine nacelle by extending a plurality of flow control devices on each engine nacelle in at least lower quadrants of an inlet circumference accommodating a high angle of attack of the nacelle.

### BRIEF DESCRIPTION OF THE DRAWINGS

The features, functions, and advantages desired can be achieved independently in various embodiments of the present disclosure or may be combined in yet other embodiments, further details of which can be seen with reference to the following description and drawings.

FIG. 1 is pictorial representation of a commercial aircraft with high bypass ratio turbofan engines;

FIG. 2A is a pictorial detail of the turbofan engine nacelle as mounted on the aircraft wing;

FIG. 2B is a partial section view of the inlet nacelle with an exemplary embodiment of the inlet flow control device as deployed demonstrating relative sizing of the flow control device and nacelle;

FIG. 2C is a first detailed side view of the inlet flow control device in the deployed position;

FIG. 2D is a second detailed lower angle pictorial view showing features of the inlet flow control device in the deployed position;

FIG. 2E is a third detailed upper angle pictorial view showing features of the inlet flow control device in the deployed position;

FIG. 3A is a front pictorial view of the inlet nacelle and engine with the flow control device in the stowed or retracted position;

FIG. 3B is a side view of the inlet nacelle and engine with the flow control device in the stowed or retracted position;

FIG. 3C is a rear pictorial view of the inlet nacelle and engine with the flow control device in the stowed or retracted position;

FIG. 3D is a detailed upper angle pictorial view showing features of the inlet flow control device in the stowed position;

FIG. 4A is a front pictorial view of the inlet nacelle and engine with the flow control device in a partially deployed position;

FIG. 4B is a side view of the inlet nacelle and engine with the flow control device in a partially deployed position;

FIG. 4C is a rear pictorial view of the inlet nacelle and engine with the flow control device in a partially deployed position;

FIG. 4D is a detailed side view showing features of the inlet flow control device in a partially deployed position;

FIG. 5A is a front pictorial view of the inlet nacelle and engine with the flow control device in a fully deployed position;

FIG. 5B is a side view of the inlet nacelle and engine with the flow control device in a fully deployed position;

FIG. 5C is a rear pictorial view of the inlet nacelle and engine with the flow control device in a fully deployed position;

FIG. 6 is a front view of the turbofan engine as mounted on the wing adjacent the fuselage with the flow control device in a fully deployed position;

FIG. 7 is a flow chart depicting a method for flow control in a turbofan engine having a short inlet.

### DETAILED DESCRIPTION

The exemplary embodiments described herein provide flow control devices for adverse flow conditions in an ultra-short nacelle inlet to solve the problem of flow distortion on the fan for a larger turbofan engine. The flow control devices are a deployable aerodynamic structure, similar to a Krueger flap on an aircraft wing, that is deployed to extend from a leading edge of the nacelle to increase the effective leading edge radius of the nacelle and give incoming air flow a better turning angle to decrease or control flow separation in off-nominal conditions such as crosswind and high angles of attack. The resulting variable geometry inlet deals with low speed high angle-off-attack problems of separated flow, while still preserving the short nacelle in the retracted position to maintain cruise performance and the overall optimum performance of the larger engine.

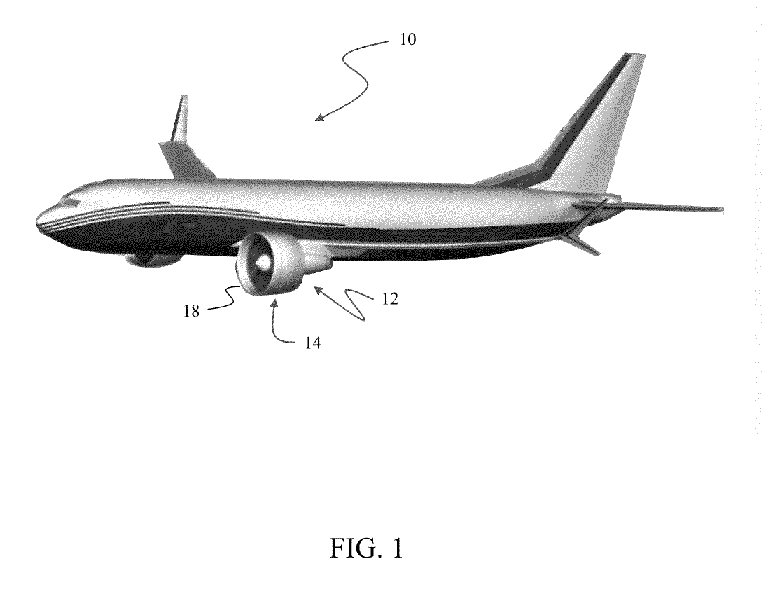

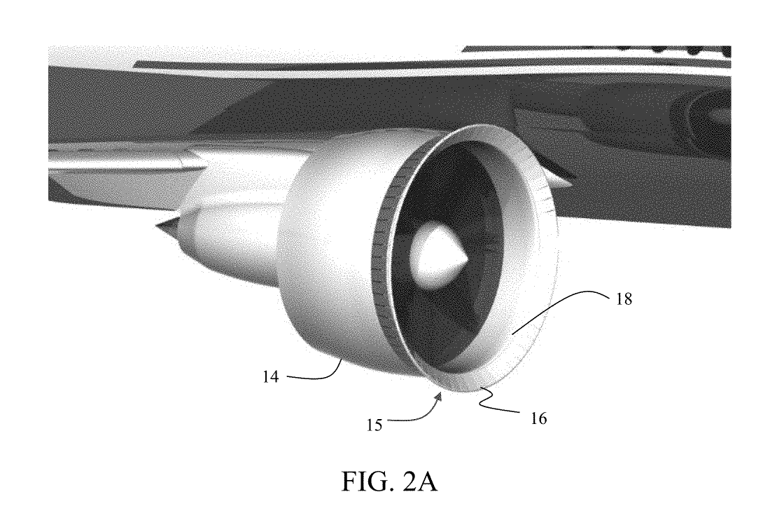

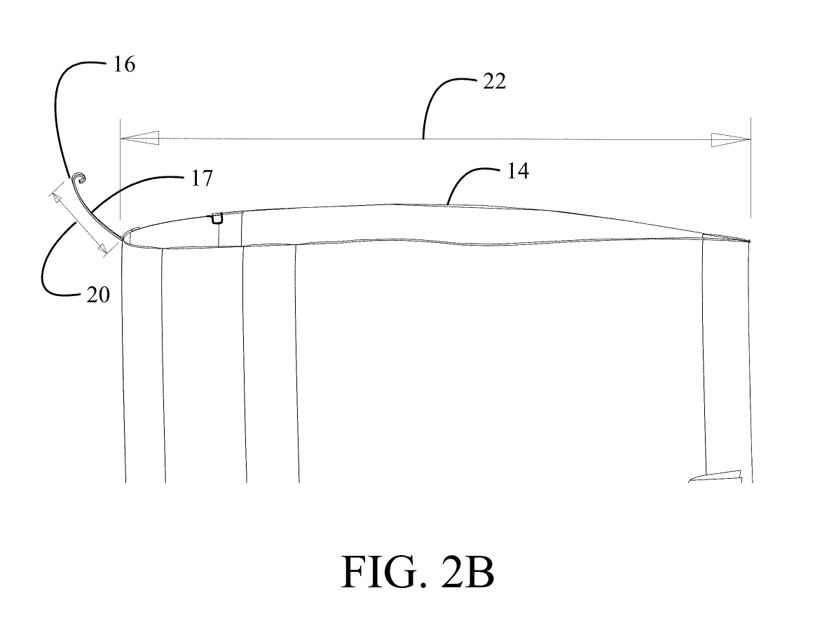

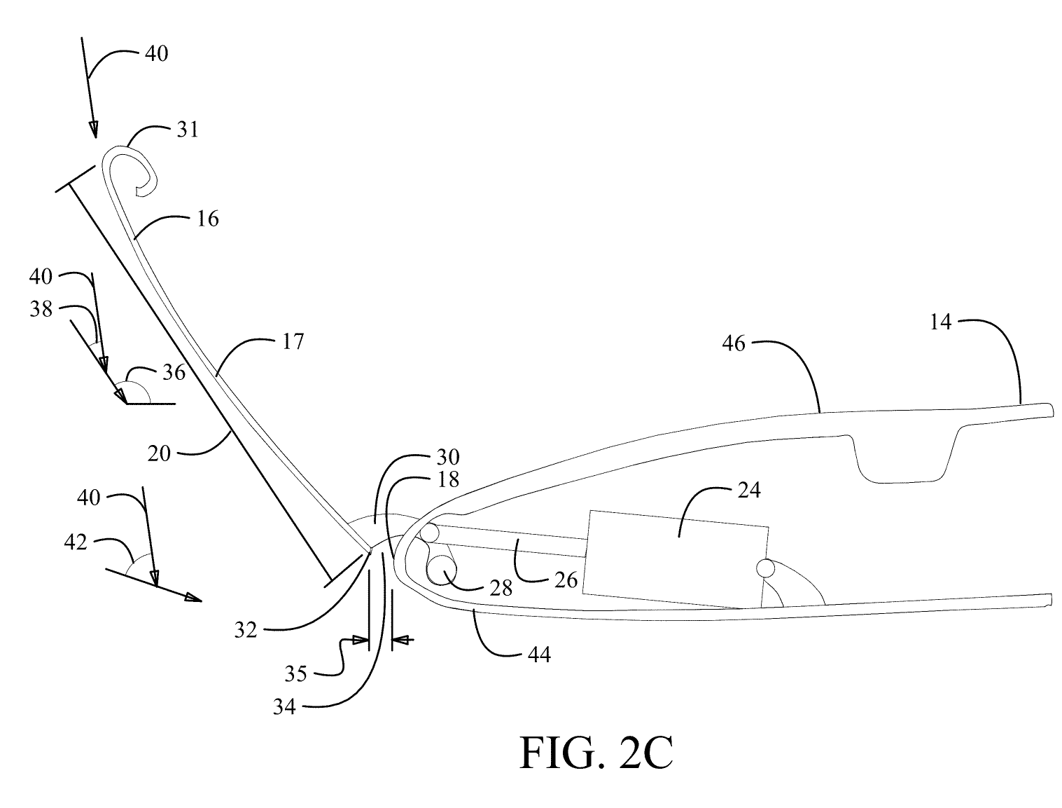

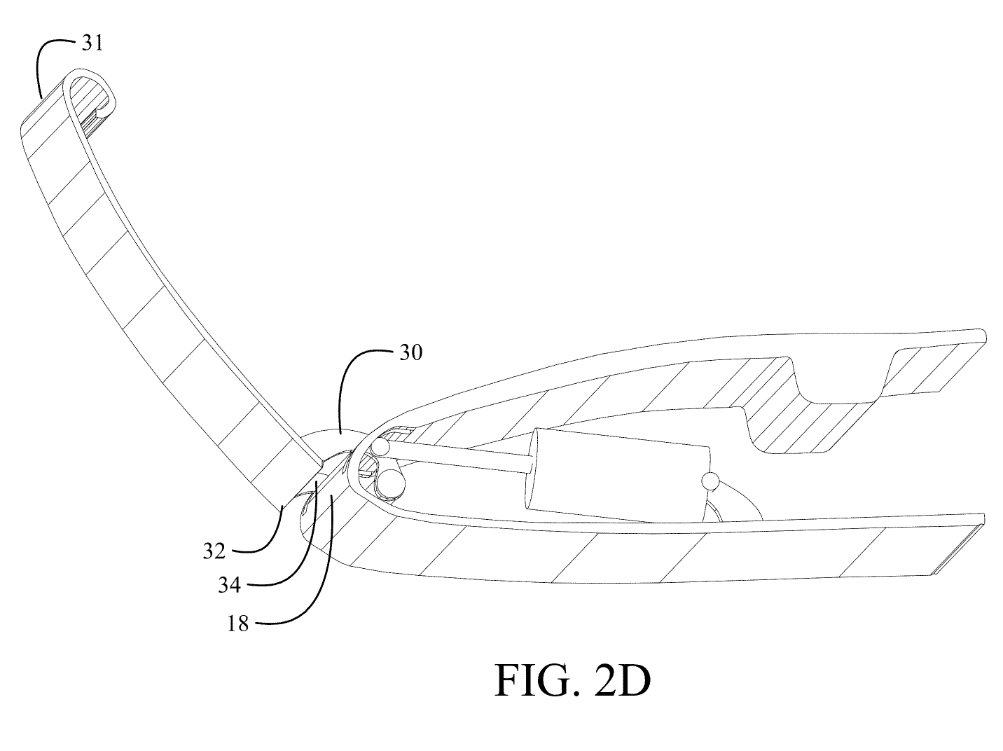

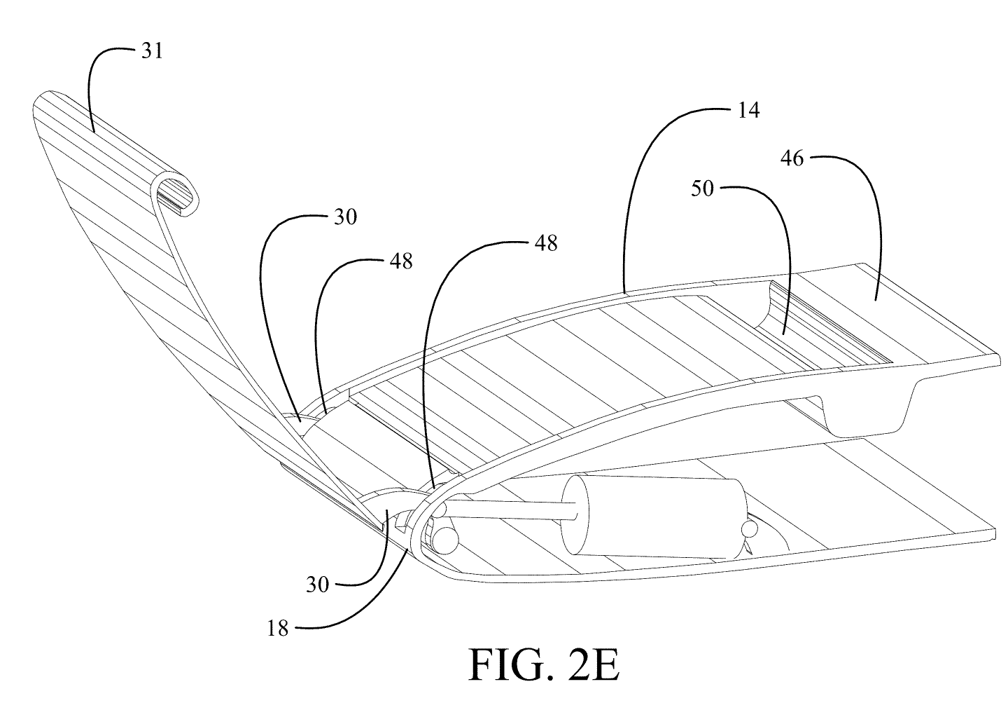

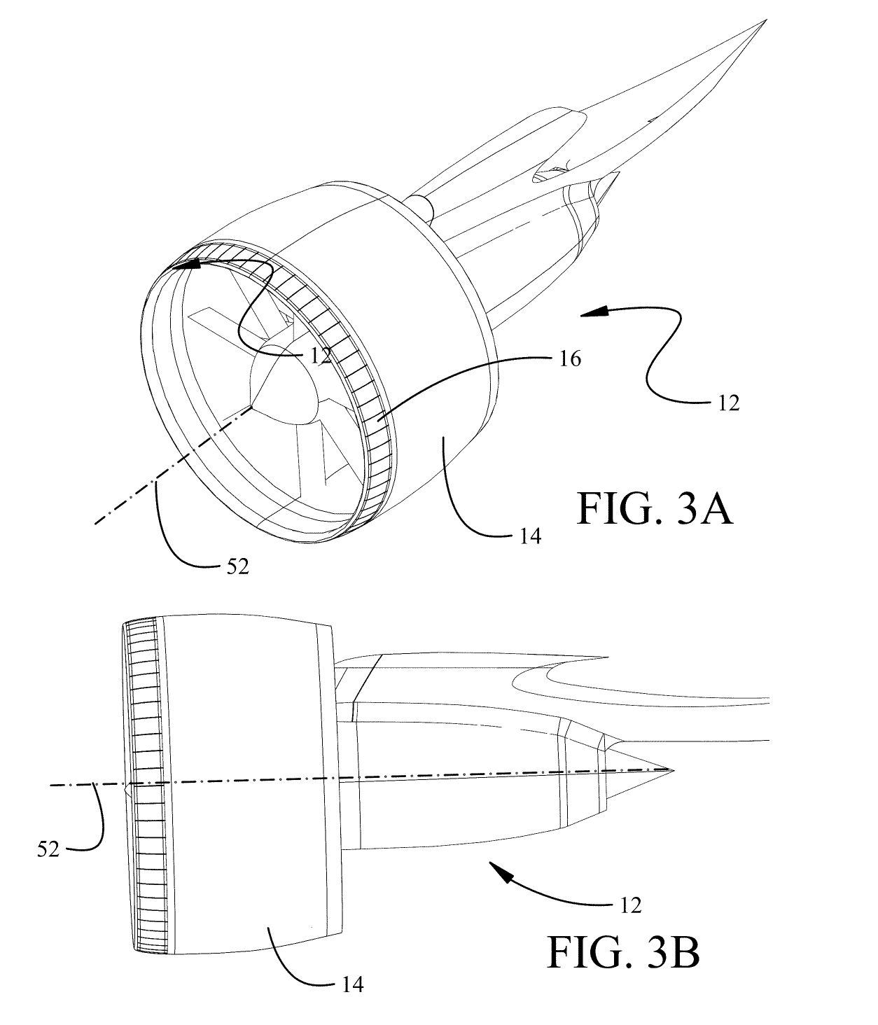

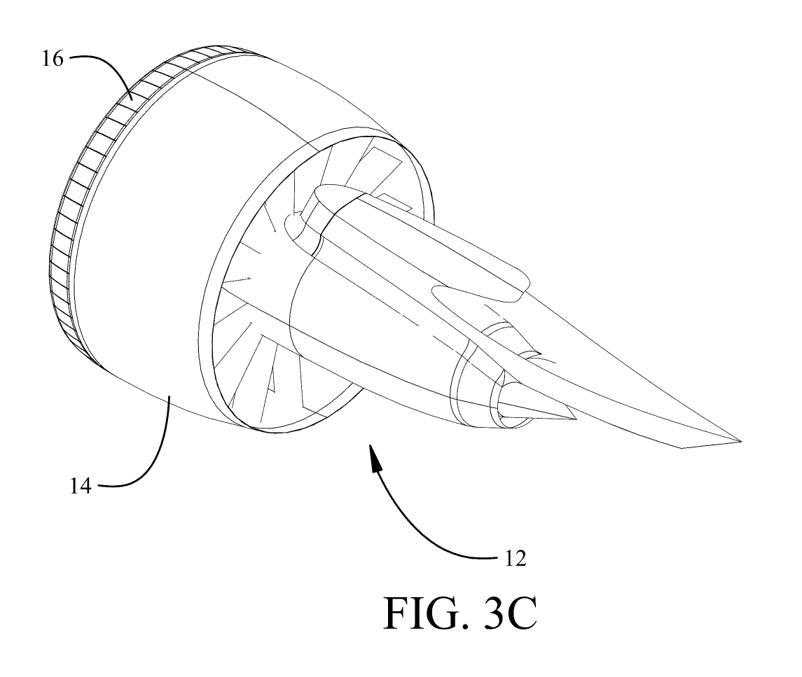

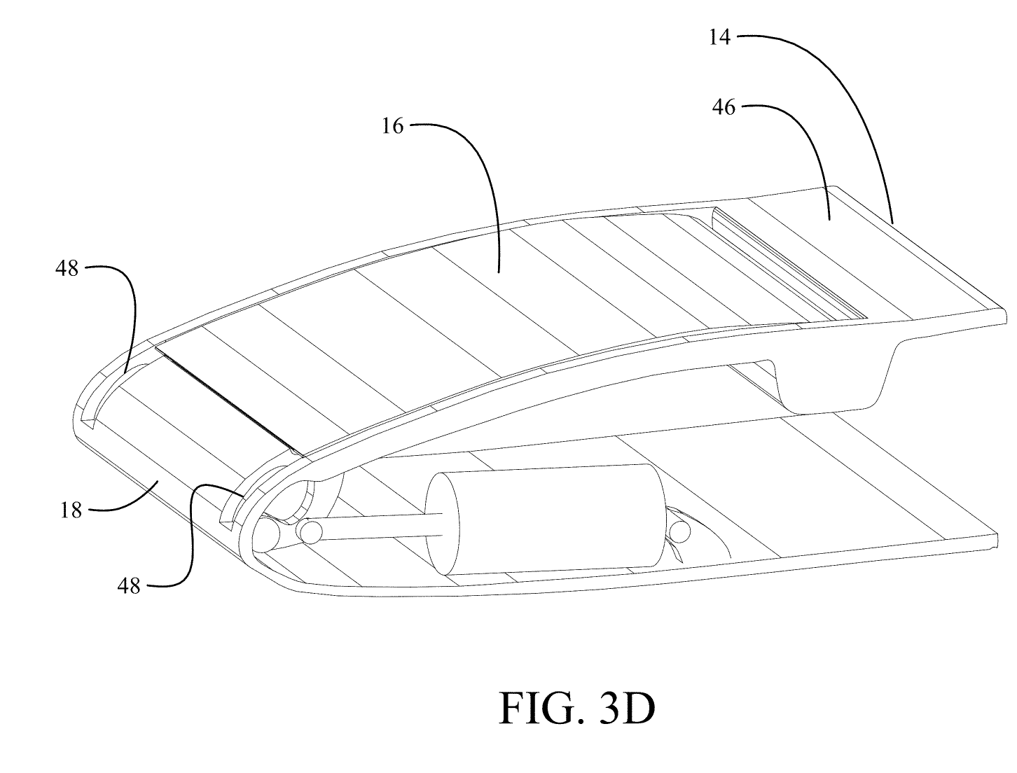

Referring to the drawings, FIG. 1 depicts a large commercial aircraft 10 employing high bypass ratio turbofan engines 12 having ultra-short nacelles 14. A radial array 15 of individual flow control devices 16 providing a flow control system are deployed at the leading edge 18 of the nacelle 14 as seen in FIG. 2A (only the flow control device 16 in perpendicular section is shown deployed for clarity). Each flow control device 16 has a cambered body 17 rotatable from a stowed position as seen in FIGS. 3A-3D (described in greater detail subsequently) to the fully deployed position seen in FIG. 2A and in detail in FIG. 2B. Each flow control device 16 has a chord length 20 which is nominally 2.5 to 25% of the nacelle length 22.

FIGS. 2C-2E show the flow control device 16 in greater detail. Each flow control device 16 is rotated from the stowed to deployed position by an actuator 24 having an actuating rod 26 connected to the body of the flow control device 16, The flow control device 16 is then rotated about an axle 28 which supports the flow control device with lever arms 30 attached to the body 17 proximate a trailing edge 32 (in the deployed position). In alternative embodiments the axle 28 may incorporate one or more rotating shape memory alloy (SMA) tubes or similar devices for actuation. While the actuator 24 and associated actuating rod 26 are shown as attached to one of two lever arms 30, in alternative embodiments, a single lever arm 30 may be centrally connected to the body 17 of each flow control device 16. Similarly, mechanical linkages may be employed to join adjacent flow control devices 16 and individual actuators 24 may rotate multiple flow control devices 16.

The lever arms 30 are configured to maintain the nacelle leading edge 18 and flow control device trailing edge 32 in a spaced relationship providing a flow slot 34 with a width 35 of approximately 0.5 to 5% of the body chord length 20 ((best seen in FIG. 2D and exaggerated in the drawing for clarity). Deployment of the flow control devices 16 increases the effective camber of the leading edge of the nacelle. Additionally, cambered shaping of the flow control device 16 from nose 31 to trailing edge 32 with angle of deployment 36 further enhances the significantly reduced initial turning angle 38 for an off-axis flow (such as a crosswind represented by arrows 40) with a smooth transition into the inlet as opposed to an initial turning angle 42 required by the aerodynamic internal contour 44 of the inlet without the deployed flow control device. While the embodiment shown provides camber in the flow control device 16, a flat contour maybe employed. The cambered contour provides additional benefit in aerodynamic smoothing of the flow control device 16 with the external contour 46 of the nacelle 14, as will be described in greater detail subsequently. A curved, blunt nose 31 aerodynamically assists air that is non-parallel to the flow control device turn onto the flow control device more easily.

For the embodiment shown, the lever arms 30 extend through slots 48 in the nacelle leading edge 18 (best seen in FIG. 2E). As previously described a centrally located lever arm 30 may be attached to the flow control device 16 and extend through a single slot. A depressed pocket 50 in the external contour 46, seen in FIG. 2E, receives at least a portion of the flow control device 16 in the retracted position to provide a relatively flush transition between the nose 31 of the flow control device and the external contour 46 of the nacelle 14, as see in FIGS. 3A-3D. Telescoping, jointed or pivoting mechanisms in the lever arms 30 may be employed to insert and engage the flow control device 16 within the pocket 50 during retraction to more closely meld with the external contour 46.

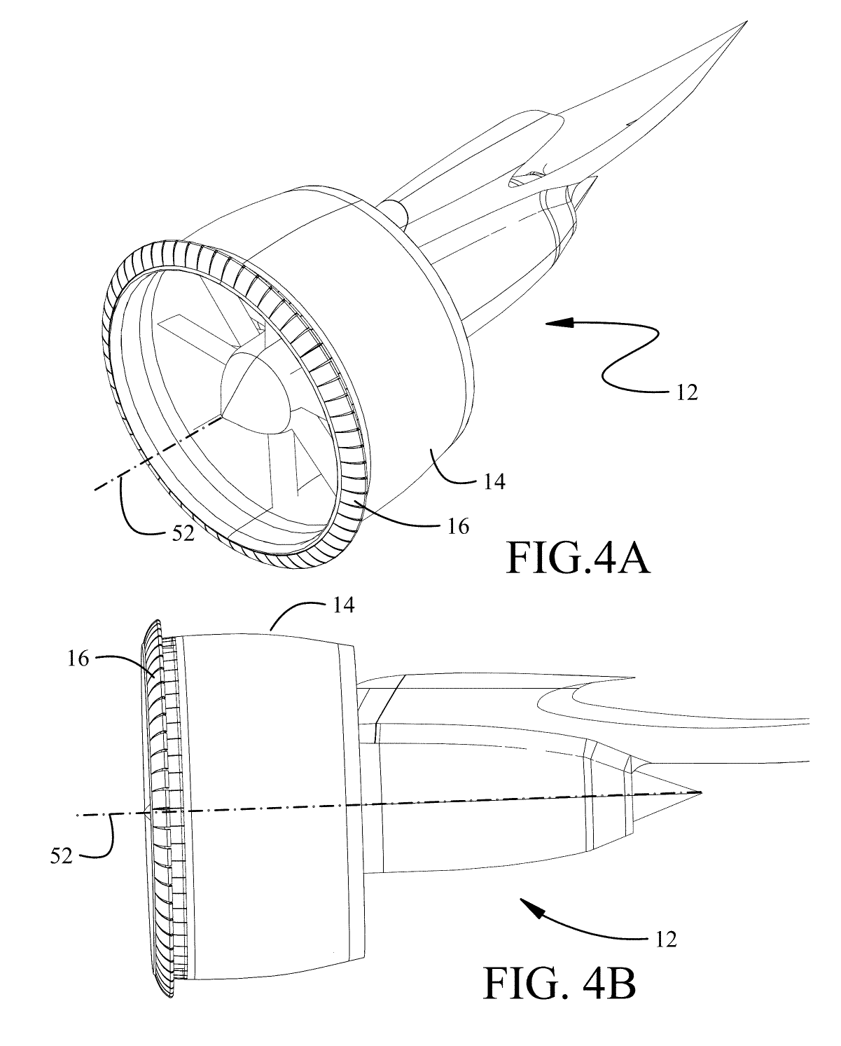

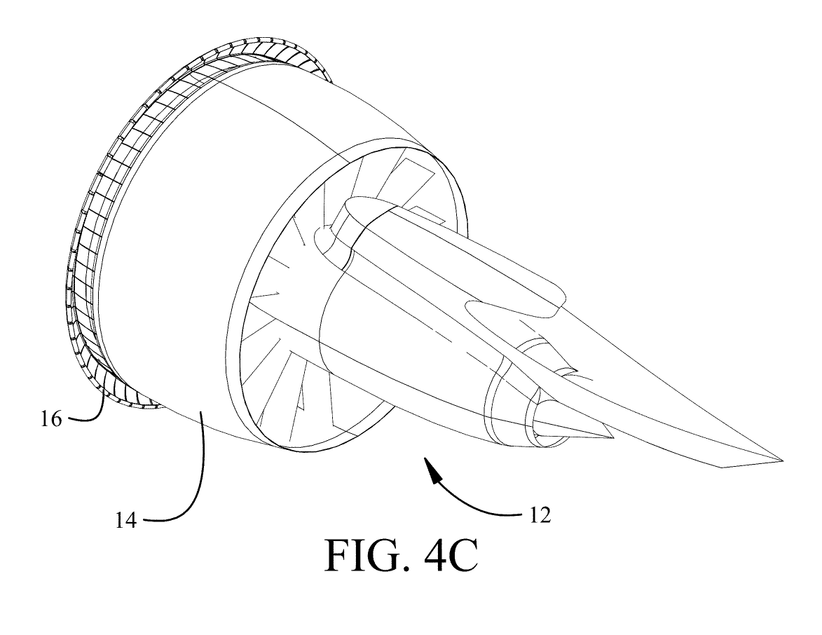

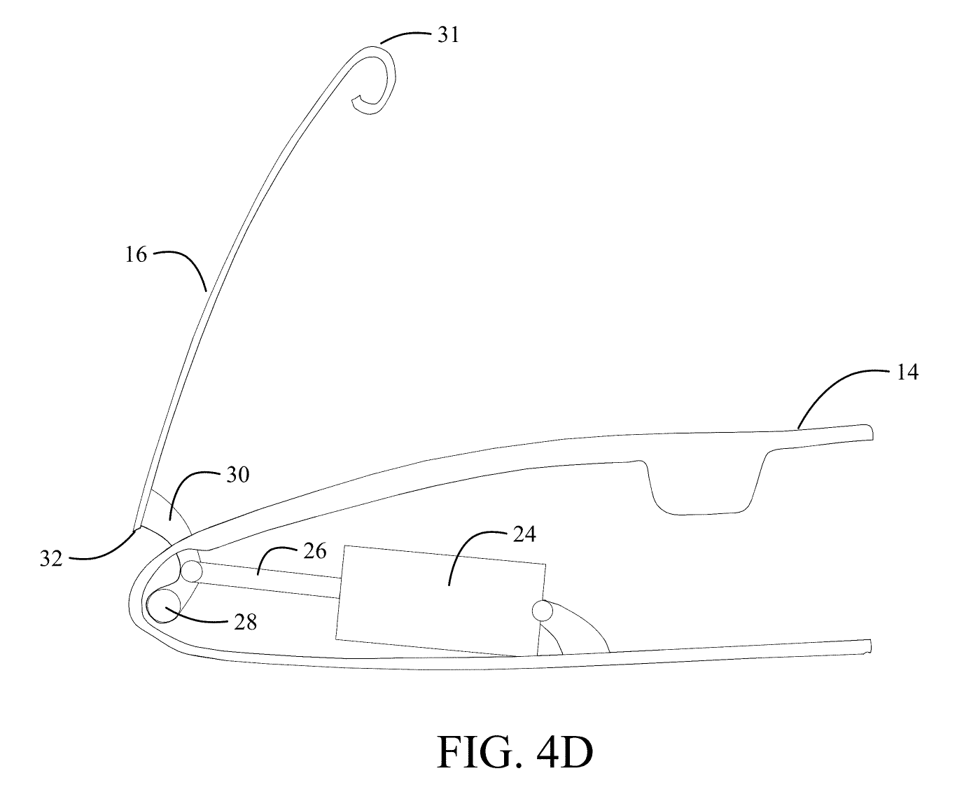

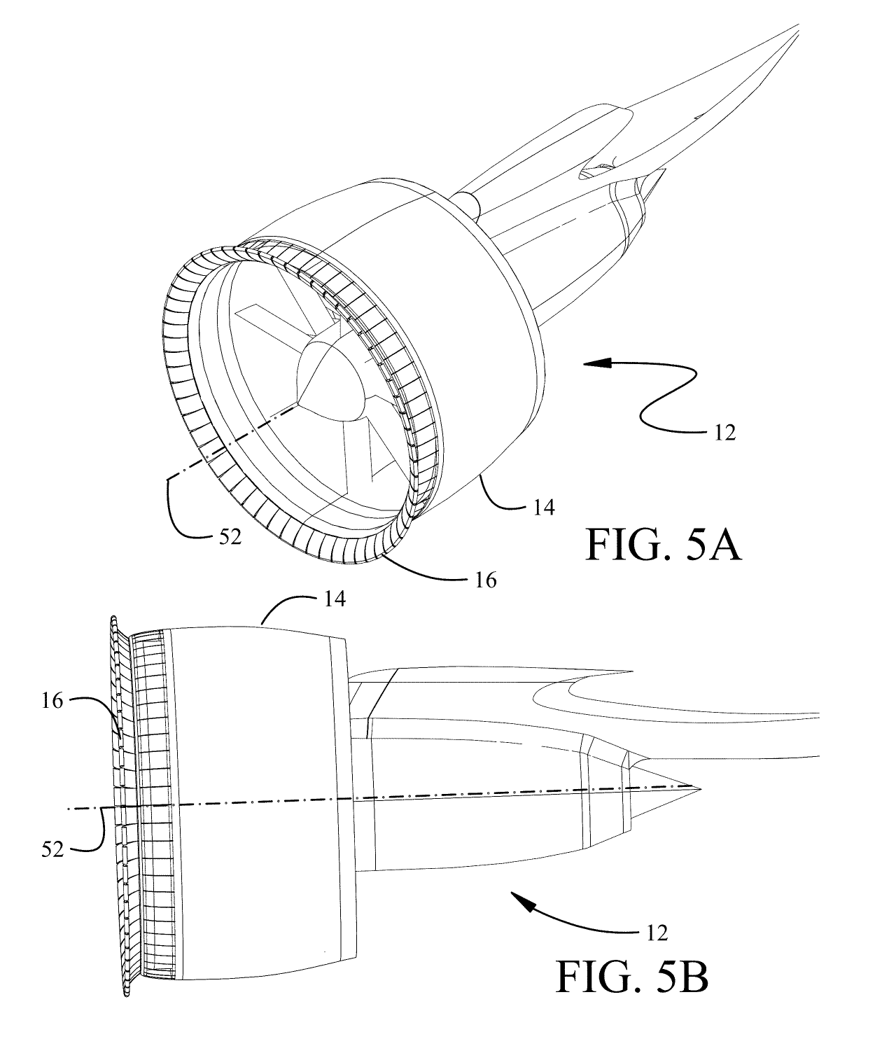

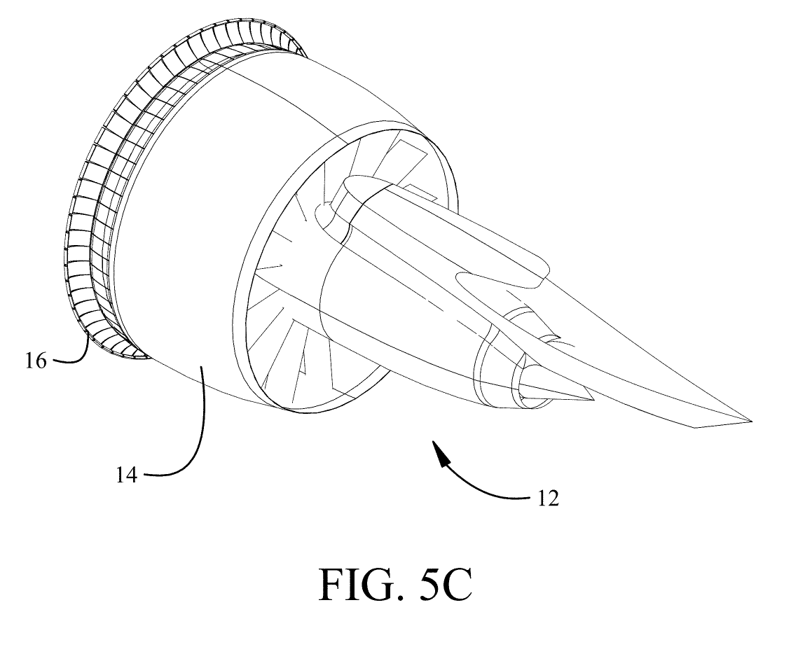

Deployment of the flow control devices 16 is demonstrated in the sequence of drawings in FIGS. 3A-3E (closed or retracted), FIGS. 4A-4C (partially extended/rotated) and FIGS. 5A-5C (fully rotated or extended). As displayed in this sequence, extension of the entire array of flow control devices 16 is symmetrical about a centerline axis 52 of the nacelle. However, in certain embodiments selectable positioning of the flow control devices 16 at various points through the range of rotation may be desirable for varying angle of attack or other issues.

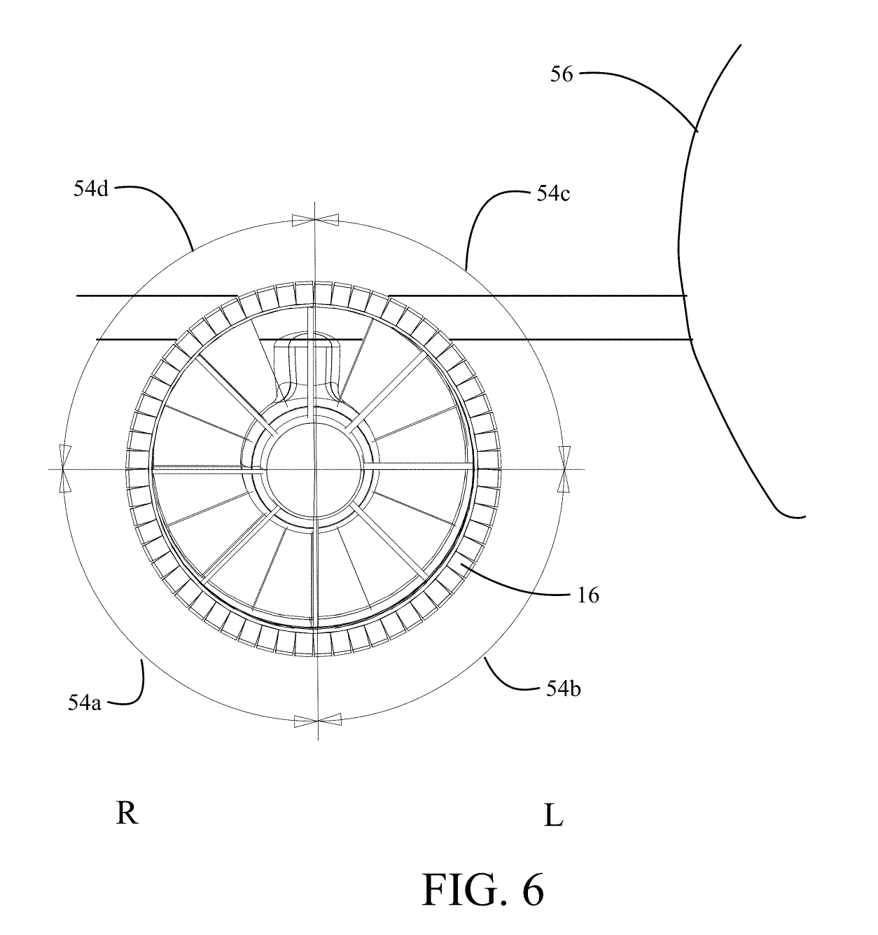

FIG. 6 shows the symmetrical extended configuration of the radial array 15 of flow control devices 16. As annotated in FIG. 6, quadrants 54a-54c around the nacelle may have differing aerodynamic conditions or effects created by angle of attack of the aircraft as a whole, cross winds, which may be partially shielded or mitigated by the fuselage 56 of the aircraft, or other aerodynamic phenomenon induced during flight, takeoff or landing of the aircraft. Each of the flow control devices 16 may be separately operable for extension and retraction. For high angle of attack operation of the aircraft, deployment of selectable groups of the flow control devices 16 in at least lower outboard and lower inboard quadrants 54a and 54b would likely be desirable. For a strong outboard cross wind from the right, R, of the aircraft (left on the drawings as a front view of the aircraft), deployment of the flow control devices grouped in lower and upper outboard quadrants 54a and 54d would be desirable. Similarly, for a strong inboard cross wind from the left, L, of the aircraft (right on the drawing) deployment of the flow control devices grouped in lower and upper inboard quadrants 54b and 54c may be desirable. However, presence of the fuselage 56 may block left cross wind flow and deployment of the flow control devices in upper inboard quadrant 54c may not be required. The descriptions herein are reversed for left and right designations for an engine mounted on the left side of the aircraft. Additionally, while shown in the drawings as equal quadrants, the “quadrants” may be interpreted as any selected arcuate segments of the circumference of the inlet.

For aircraft with certain operating conditions or engine mounting configurations, the array of flow control devices may be altered to include only active devices in lower quadrants 54a and 54b, or those quadrants plus a lower portion of quadrants 54c and 54d which would be sufficient to accommodate all needed aerodynamic conditions.

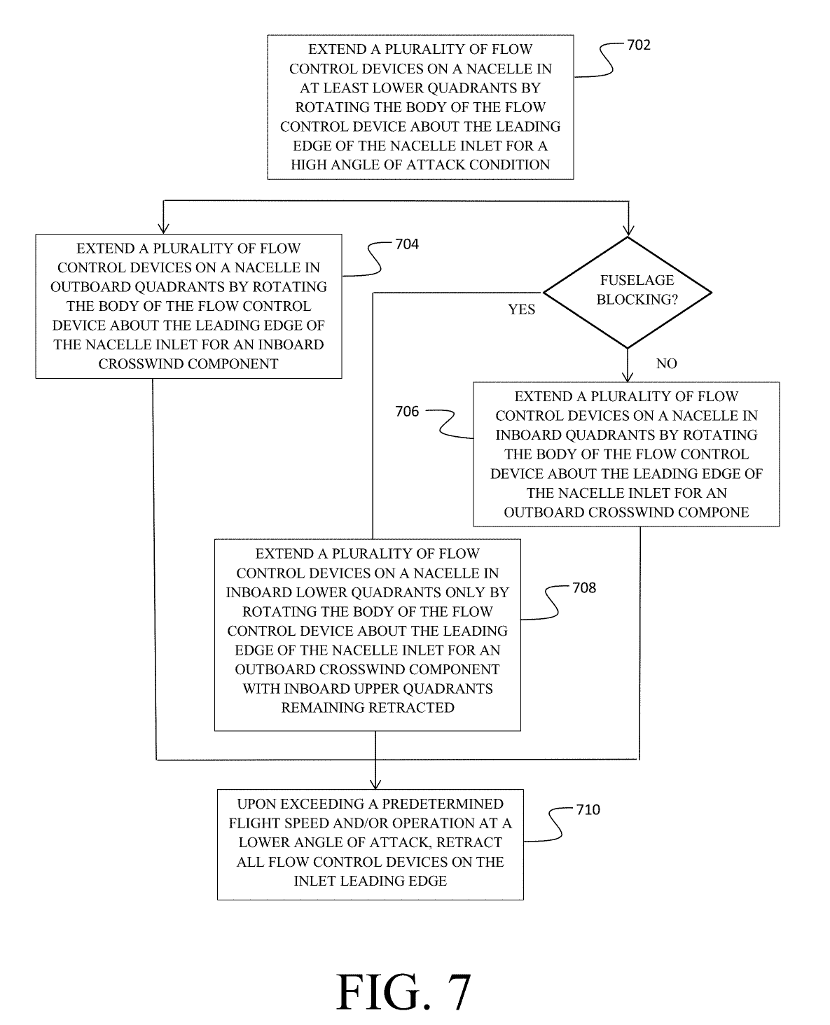

The embodiments disclosed herein provide a method for inlet flow control on an ultra-short turbofan engine nacelle as shown in FIG. 7. For an expected predetermined high angle of attack condition a plurality of flow control devices 16 on each engine may be extended in at least lower quadrants 54a, 54b of the inlet circumference by rotating the body 17 of each flow control device about the leading edge 18 of the nacelle inlet, step 702. With a predetermined outboard wind component (i.e. blowing from the outboard side of the nacelle) a plurality of flow control devices 16 may be extended in at least the outboard quadrants 54a, 54d of the inlet circumference, step 704. For a predetermined inboard cross wind component a plurality of flow control devices 16 may be extended in at least the inboard quadrants 54b, 54c of the inlet circumference, step 706, or where fuselage blocking or mitigation of the inboard cross wind is anticipated, flow control devices 16 in the upper inboard quadrant may remain retracted and only flow control devices 16 in the lower inboard quadrant are extended, step 708. Upon exceeding a predetermined flight speed and/or reducing operation to a lower angle of attack, all flow control devices 16 are retracted, step 710.

Having now described various embodiments of the disclosure in detail as required by the patent statutes, those skilled in the art will recognize modifications and substitutions to the specific embodiments disclosed herein. Such modifications are within the scope and intent of the present disclosure as defined in the following claims.

What is claimed is:

1. A flow control system on an engine nacelle, the system comprising:
a plurality of flow control devices each having a body; and
a second plurality of actuators, each actuator coupled to the body of at least one associated flow control device and configured to rotate the body about a leading edge of an inlet of a nacelle from a retracted position to an extended position.

2. The flow control system as defined in claim 1 wherein the body of each flow control device in the plurality of flow control devices has a nose and a chord length from the nose to a trailing edge of about 2.5% to 20% of a length of the nacelle.

3. The flow control system as defined in claim 1 further comprising an axle for each flow control device, said axle connected to each body with at least one lever arm, said axle configured for rotation by at least one of the second plurality of actuators.

4. The flow control system as defined in claim 3 wherein said at least one lever arm is configured to maintain a spaced relationship between a trailing edge of the body and the leading edge of the inlet of the nacelle such that a flow slot is formed therebetween.

5. The flow control system as defined in claim 4 wherein the flow slot has a slot width of about 0.5% to 5% of a body chord length.

6. The flow control system as defined in claim 1 wherein the body is cambered.

7. The flow control system as defined in claim 6 further comprising a pocket in an external contour of the nacelle shaped to receive at least a portion of the body with a nose of the body being substantially flush with the external contour of the nacelle.

8. The flow control system as defined in claim 1 wherein a number of actuators of the second plurality of actuators is equal to a number of flow control devices of the plurality of flow control devices.

9. The flow control system as defined in claim 8 wherein each flow control device of the plurality of flow control devices is separately extendible.

10. The flow control system as defined in claim 1 wherein selectable groups of the plurality of flow control devices are simultaneously extendible.

11. The flow control system as defined in claim 10 wherein at least two of the selectable groups are located in lower quadrants of a circumference of the inlet, wherein the at least two of the selectable groups are adapted to accommodate a high angle of attack of the inlet of the nacelle.

12. The flow control system as defined in claim 10 wherein at least two of the selectable groups are located in outboard quadrants of a circumference of the inlet, wherein the at least two of the selectable groups are adapted to accommodate outboard crosswinds at the inlet of the nacelle.

13. The flow control system as defined in claim 10 wherein at least one of the selectable groups is located in an inboard quadrant of a circumference of the inlet, wherein the at least one of the selectable groups is adapted to accommodate inboard crosswinds at the inlet of the nacelle.

14. A method for inlet flow control on an engine nacelle comprising:
extending a plurality of flow control devices on a nacelle by rotating a body of each flow control device about a leading edge of an inlet of the nacelle in at least one lower quadrant of an inlet circumference accommodating a high angle of attack of the inlet of the nacelle.

15. The method of claim 14 further comprising extending a plurality of flow control devices in at least one outboard quadrants of the inlet circumference accommodating a predetermined outboard wind component.

16. The method of claim 14 further comprising extending a plurality of flow control devices in at least one inboard quadrant of the inlet circumference accommodating a predetermined inboard wind component.

17. The method of claim 14 further comprising extending a plurality of flow control devices in a lower inboard quadrant of the inlet circumference accommodating a predetermined inboard wind component with a plurality of flow control devices in an upper inboard quadrant remaining retracted.

18. The method of claim 14 further comprising retracting all flow control devices upon exceeding a predetermined flight speed or operation at a lower angle of attack.

19. An aircraft engine nacelle comprising:
a leading edge defining an inlet opening for air flow into a nacelle; and
a plurality of flow control devices, each flow control device being rotatable about the leading edge from a retracted position to an extended position.

20. The aircraft engine nacelle as defined in claim 19 wherein selectable groups of the plurality of flow control devices are simultaneously extendible.
